(19) United States
(12) Patent Application Publication
(10) Pub. No.: US 2005/0235461 A1
(43) Pub. Date: Oct. 27, 2005

(54) Compression finial

(76) Inventor: Timothy V. George, Smithfield, UT (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 11/168,169

(22) Filed: Jun. 27, 2005

Related U.S. Application Data
(63) Continuation-in-part of application No. 11/098,032, filed on Mar. 31, 2005.
(60) Provisional application No. 60/558,531, filed on Mar. 31, 2004.

(51) Int. Cl. F21S 8/00

(52) U.S. Cl. 16/387

(57) ABSTRACT

A finial is provided for a hinge having a plurality of knuckles and a hinge pin. The finial includes a finial body substantially similar in size to the hinge pin. A finial head is coupled to the finial body, and the finial head is configured to stop the final as it is fit into a knuckle of the hinge. A channel is formed into the finial body. A compressible ring is contained partially within the channel.

### CROSS-REFERENCE TO RELATED APPLICATIONS AND CLAIM OF PRIORITY

Priority of U.S. Provisional patent application Ser. No. 60/558,531 filed on Mar. 31, 2004 and United States non-provisional patent application Ser. No. 11/098,032 filed on Mar. 31, 2005 is claimed.

### BACKGROUND

High-end hinges have threaded finials that are screwed into the hinge. One of the on-going problems with high-end door hinges concerns the finial frequently working its way out of the hinge. When the hinge operates, the pin rotates and eventually causes the bottom finial to back out and fall to the ground. In some situations, the finials are lost and are then re-ordered which costs the owner of the door additional money. Even if the finial is not lost, then the finial may frequently need to be screwed back into the hinge on a periodic basis.

### SUMMARY

The present invention includes a finial for a hinge having a plurality of knuckles and a hinge pin. The finial includes a finial body substantially similar in size to the hinge pin. A finial head is coupled to the finial body, and the finial head is configured to stop the finial as it is fit into a knuckle of the hinge. A compressible ring is disposed on the finial body.

In accordance with another aspect, a channel is formed into the finial body. The compressible ring is contained partially within the channel.

In accordance with another aspect, a hinge has a first knuckle having at least one hinge pin eyelet and a second knuckle, having at least one hinge pin eyelet alignable with the at least one hinge pin eyelet of the first knuckle. A hinge pin is disposable in the eyelets of the first and second knuckles. The first and second knuckles are pivotable about the hinge pin when disposed in the eyelets. The hinge includes a top and a bottom finial that are disposable above and below the hinge pin in the aligned eyelets. Each finial includes a finial body, a finial head, and a compressible ring. The finial head is abuttable against a shoulder of a knuckle to stop the finial as the finial body is disposed within an eyelet of the knuckle. The compressible ring is disposable circumferentially around the finial body.

The present invention also includes a method for securing a hinge pin in a hinge having a plurality of knuckles. The method includes aligning eyelets of adjacent knuckle sections of the hinge with one another. A lower finial, including a compressible ring disposed on the finial body, can be pressed into a lower opening of the adjacent eyelets until a finial head of the lower finial stops movement of the lower finial and covers the eyelet. A pin can be placed into an upper opening of the aligned eyelets toward the lower opening of the aligned eyelets until the lower finial stops movement of the pin. An upper finial, including a compressible ring disposed on the finial body, can be pressed into the upper opening of the aligned eyelets until a finial head of the upper finial stops movement of the upper finial and covers the eyelet.

In accordance with another aspect, the invention provides a method for preventing inadvertent movement of a finial within a hinge assembly. The method can include obtaining a finial having a finial body, and a compressible ring disposed on the finial body. The finial can be pressed into an eyelet of a knuckle section of a hinge such that the compressible ring engages the eyelet and compresses about the finial body section, thereby resisting movement of the finial within the eyelet. Additionally, the compressible ring can be placed at least partially within a circumferential groove formed in the finial body before the finial is pressed into the eyelet.

### BRIEF DESCRIPTION OF THE DRAWINGS

FIG. 1 is a perspective view of a finial in an embodiment of the invention;

FIG. 2 illustrates an exploded perspective view of the finial of FIG. 1;

FIG. 3 is a cross section view of the finial of FIG. 1;

FIG. 4 is a top view of a compressible ring in an embodiment of the invention;

FIG. 5 depicts a cross section of the compressible ring of FIG. 4;

FIG. 6 illustrates an exploded perspective view of the finial in a hinge assembly;

FIG. 7 illustrates a cross section view of the finial and hinge assembly of FIG. 6;

FIG. 8 illustrates a perspective view of the finial and hinge assembly of FIG. 6;

FIG. 9 illustrates an exploded perspective view of the finial of another embodiment of the present invention; and

FIG. 10 illustrates a cross section view of the finial of FIG. 9.

### DETAILED DESCRIPTION OF EXAMPLE EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides a finial which can prevent the finial from backing out of the hinge and falling to the floor. The finial of the present invention uses a compressible ring to resist movement of the finial and to eliminate threading on the finial. Therefore, when the hinge rotates, the finial is no longer able to rotate and fall out. This finial configuration can apply to all shapes, sizes, and ornamental types of hinges and finials.

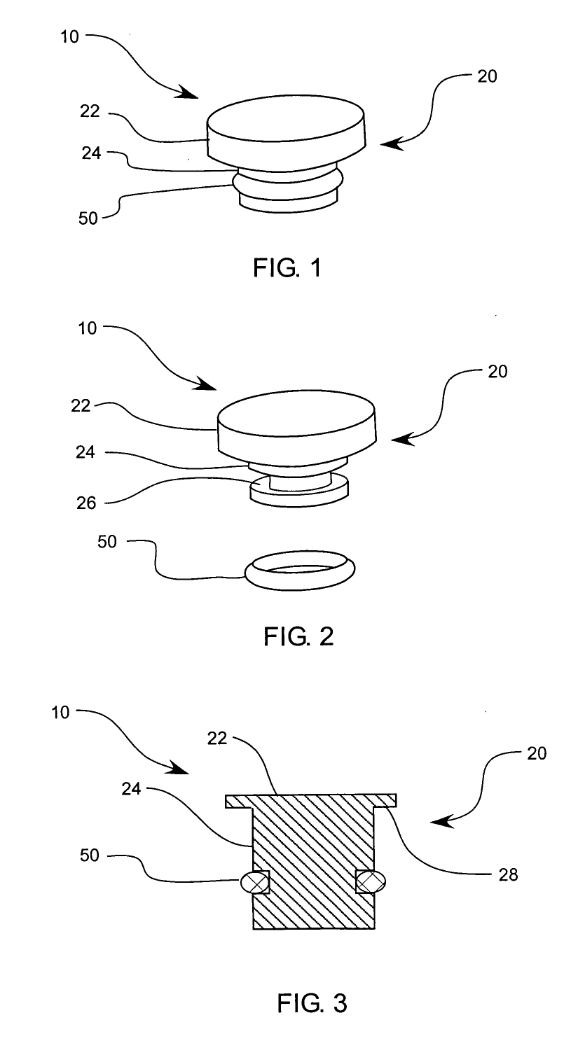

As illustrated in FIGS. 1-3, a finial, indicated generally at 10, in accordance with the present invention is shown for use in a hinge. Specifically, FIG. 1. illustrates a perspective view of a finial 20 assembled with a compression ring or insert 50. FIG. 2 illustrates a detailed exploded view of the finial 20 and compressible ring or insert 50. FIG. 3 illustrates a cross section view of a finial assembled into a hinge 100. As used herein, the term “insert” is to be understood to refer to a member or device that is substantially arcuate and can form a substantial ring or circle, or may form just a portion of a ring or circle. For example, an insert can form only slightly greater than half of a circle (e.g. the insert can be slightly greater than 180 degrees in arc).

The finial 20 has a finial head 22 and a finial body 24. The finial body can be substantially cylindrical. The finial head can also be cylindrical and can have a larger diameter than the finial body. The transition between the finial head diameter and the finial body diameter may form a shoulder 28. The finial head may be a simple button head as shown in FIGS. 1-10, or may be ornamental to suit the aesthetic characteristics of the hinge.

A channel 26 can be formed circumferentially around the finial body 24. The channel can be a square groove as shown in FIG. 1. The channel can also be rounded or any other shape suitable for positioning and containing at least a portion of a compressible ring 50.

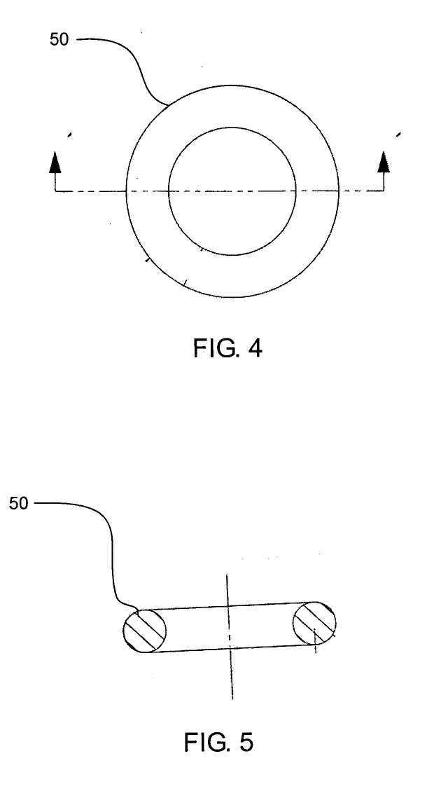

The compressible ring 50, as illustrated in FIGS. 4-5, can be disposed in the channel 26. The compressible ring can be elastically deformable, such as an elastomeric o-ring. An elastically deformable compressible ring can return to its uncompressed configuration after being used, and can be used multiple times. The compressible ring can also be made from a plastically deformable material, such as a copper compression washer. A plastically deformable compression ring remains deformed after initial use, but may provide better sticking friction in a compressed state.

It should be realized that any material that can be compressed may be used for the compressible ring as described. These materials may include rubber, plastic, soft metal, or materials with similar properties. Furthermore, the ring does not necessarily need to be an O-ring shape. A ring that is shaped more like a gasket with squared off edges, a rectangular cross section, a diamond shape, a bevel, or some other non-O shaped cross section, can also be used. Alternatively, the compressive material does not necessarily need to be an entire ring. Partial rings, strips, or pieces of material may be located in the groove in the finial in order to hold the finial in the hinge. The material used in the groove can be removable or it may be fixed into the groove.

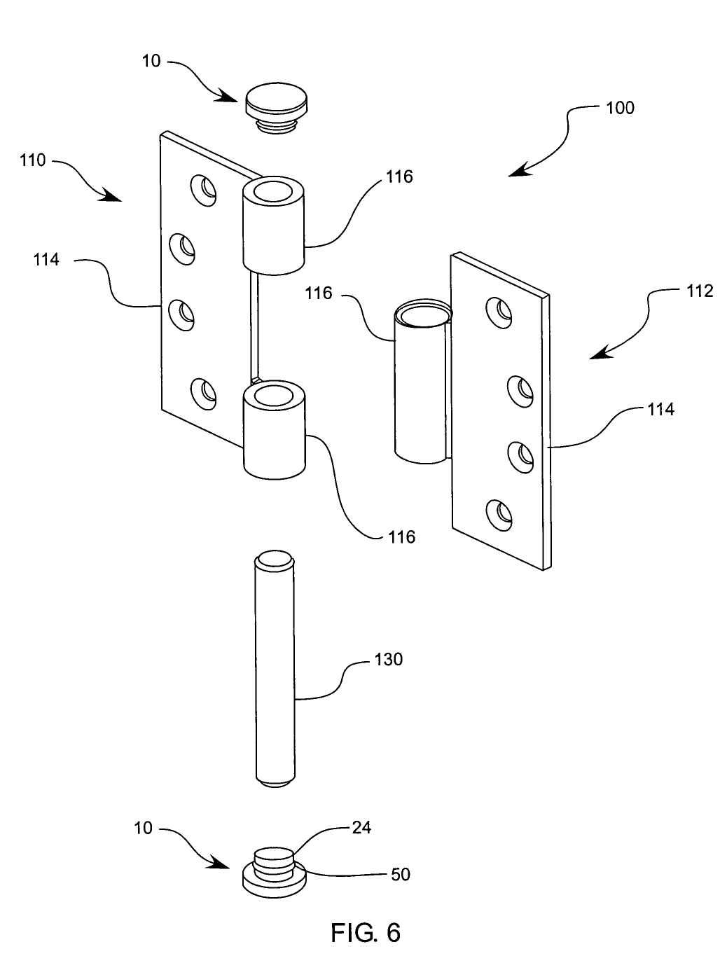

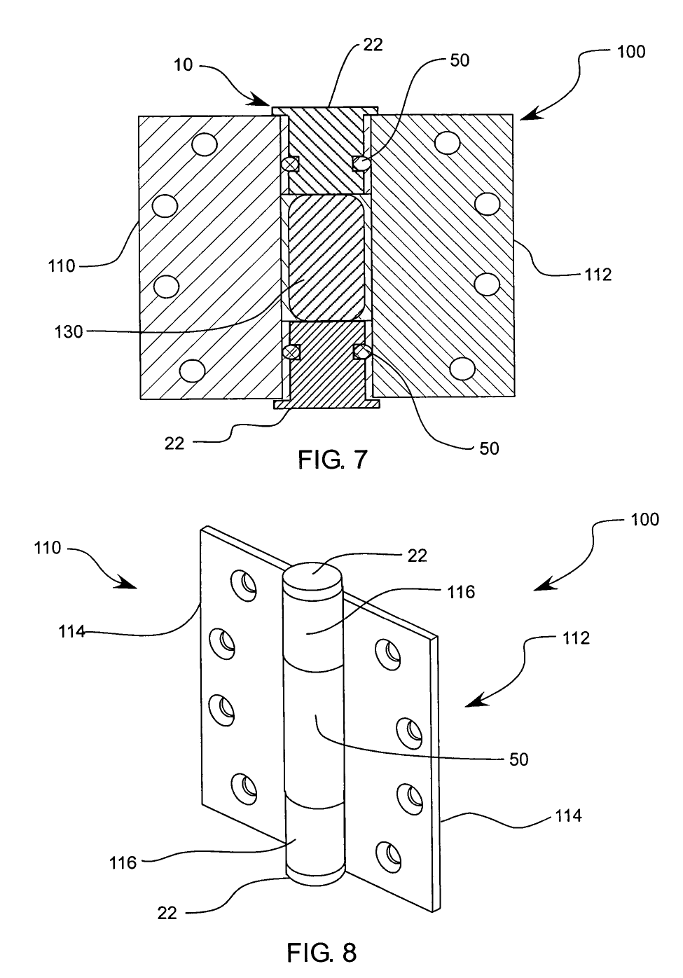

Referring to FIGS. 6-8, a pair of finials 10 is illustrated in relation to a hinge 100 in accordance with an embodiment of the present invention. Specifically, FIG. 6 illustrates an exploded view of a hinge assembly including an upper and lower finial. FIG. 7 illustrates a cross section of a hinge assembly including upper and lower finials. FIG. 8 illustrates a perspective view of a hinge assembly including an upper and lower finial.

The hinge 100 can have a first knuckle 110 and second knuckle 112. Each knuckle can have a mounting portion 114 and at least one eyelet 116. The mounting portions can attach the hinge to structure suitable for hinge use, such as doorframes, doors, cabinets and the like.

The eyelets 116 of the first and second knuckles 110 and 112 can be aligned so that they form a continuous shaft. The eyelets can also be spaced apart so that every other eyelet in the aligned configuration belongs to the same knuckle. For example, as shown in FIGS. 3-4, the eyelets of the first knuckle can be spaced apart to receive the eyelet of the second knuckle between them when the eyelets are aligned. It will be appreciated that the number and spacing of the eyelets is not critical the practice of the invention, but that any eyelet configuration known to those skilled in the art will work.

A hinge pin 130 can be disposed in the aligned eyelets 116 to secure the alignment of the eyelets 116. The first knuckle 110 and second knuckle 120 can pivot about the hinge pin when the hinge pin is disposed inside the eyelets. The diameter of the hinge pin and the finial body 24 can be similar in size to provide a tight fit within the eyelets 116.

In the hinge assembly of FIGS. 6-8, a finial 10 can be disposed in the aligned eyelets 116 above the hinge pin 130 and another finial can be disposed below the hinge pin. When the finial using the compressible ring 50 is inserted into aligned eyelets, the material of the compressible ring compresses and then retains the finial in the hinge. The compressible ring can retain the finial in the hinge due in part to the friction and expansion forces between the compressible ring and the eyelets. There may even be some suction or vacuum effect that is created by an elastically compressible ring. The finial can be inserted by simply twisting or press fitting the finial into the hinge. Then the finial will not be worked loose from the hinge because it does not have any thread. The finial may be removed by intentionally twisting or pulling the finial loose. However, the normal opening and closing of the hinge will not generally work the finial loose. Additionally, an O-ring can seal the hinge pin within the hinge 100, sealing out corroding moisture, salt, and air. Thus, the life of the hinge and hinge pin may be extended by the present compression finial.

In addition to the advantages previously discussed, the finial 10 of the present invention provides other benefits. For example, because the finial does not fall out like other threaded finials, this saves the door owners or maintainers the maintenance time that it would otherwise take to thread a finial back into the hinge 100. In addition, when one or more finials fall on the floor, this can create an unsafe situation. The finial of the present invention is unlikely to fall on the floor and provides increased safety as compared to the threaded finials.

There is also a cost savings when using the present finial 10 because threaded finials can get lost when they fall on the floor. Since the finial with a compressible ring 50 is unlikely to fall on the floor and get lost, then the finial does not need to be replaced and this saves money. Savings are also realized for the manufacture of the present invention because the finial does not need to be threaded like other finials. When threaded finials are manufactured the threading step is a time consuming manufacturing step that can be avoided by the present invention.

In addition, the present compression finial 10 saves install time at the site because the finials do not need to be unthreaded when the hinge is unpacked and then re-threaded in when the hinge is installed. The finials of the present invention can be installed with a simple twisting motion and/or with pressure applied. In addition, the finials do not need to be twisted into place when the hinges are being shipped from the manufacturing facility where they are made.

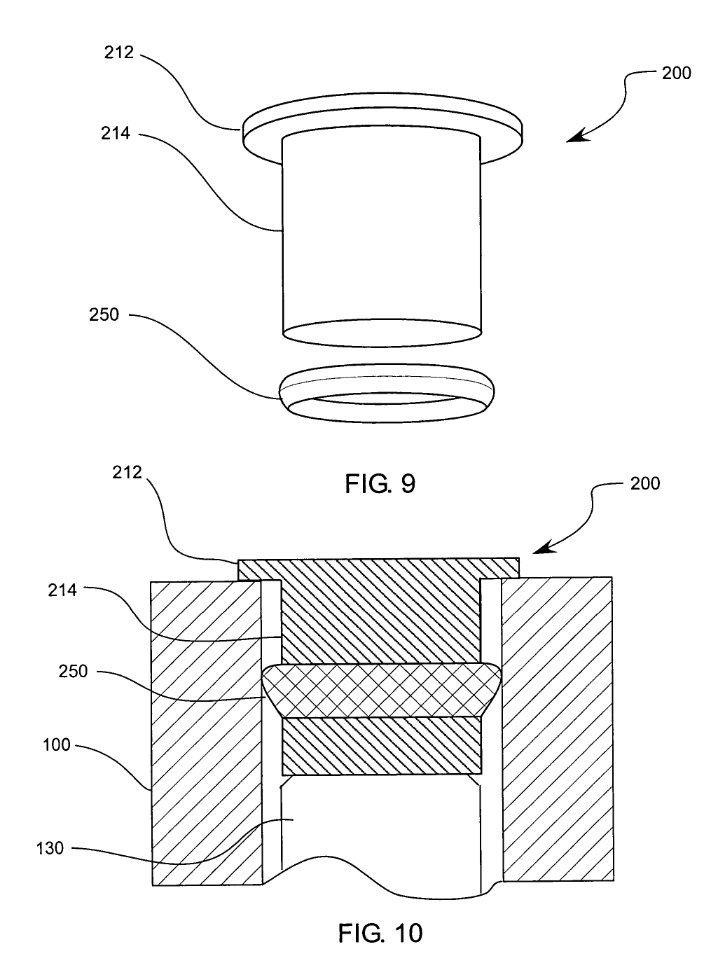

Turning now to FIGS. 9-10, a finial 200 is illustrated for a hinge in accordance with another embodiment of the present invention. Specifically, FIG. 9 illustrates an exploded perspective view of the finial 200, and FIG. 10 shows a cross section view of the finial installed into a hinge 100.

The finial 200 is similar to the embodiment of FIGS. 1-8, except it does not have a channel to partially contain the compressible ring. Otherwise, the finial in FIGS. 9-10 has the same advantages as discussed above.

The finial 200 has a finial head 212 and a finial body 214. The finial body can be substantially cylindrical. The finial head can have a larger diameter than the finial body. The transition between the finial head diameter and the finial body diameter can form a shoulder 218. A compressible ring 250 can be disposed on the finial body 214. The compressible ring can be plastically deformable, to provide better sticking friction in a compressed state. Therefore, the finial is likely to remain substantially in place on the finial body during insertion into the eyelets, as well as provide a better retentive force to the finial when in the eyelet. Alternatively, a groove may be cut in the inside of the eyelet for retaining the finial and compression ring.

A method for securing a hinge pin in a hinge having a plurality of knuckles includes aligning eyelets of adjacent knuckle sections of the hinge with one another. A lower finial, including a compressible ring disposed on the finial body, can be pressed into a lower opening of the adjacent eyelets until a finial head of the lower finial stops movement of the lower finial and covers the eyelet. A pin can be placed into an upper opening of the aligned eyelets toward the lower opening of the aligned eyelets until the lower finial stops movement of the pin. An upper finial, including a compressible ring disposed on the finial body, can be pressed into the upper opening of the aligned eyelets until a finial head of the upper finial stops movement of the upper finial and covers the eyelet.

A method for preventing inadvertent movement of a finial within a hinge assembly can include obtaining a finial having a finial body, and a compressible ring disposed on the finial body. The finial can be pressed into an eyelet of a knuckle section of a hinge such that the compressible ring engages the eyelet and compresses about the finial body section, thereby resisting movement of the finial within the eyelet. Additionally, the compressible ring can be placed at least partially within a circumferential groove formed in the finial body before the finial is pressed into the eyelet.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A finial for use with a hinge that includes a plurality of knuckles and a hinge pin, the finial comprising:
a finial body, having an outside diameter substantially the same size as an outside diameter of the hinge pin;
a finial head, coupled to the finial body, abuttable against a shoulder of one of the knuckles to stop the finial as the finial body is disposed within a knuckle; and
a compressible ring, disposable on the finial body, and within the knuckle of the hinge to resist movement of the finial body relative to the knuckle of the hinge.

2. A finial for a hinge in accordance with claim 1, further comprising a channel formed circumferentially around the finial body, configured to at least partially contain the compressible ring.

3. The finial in accordance with claim 2, wherein the channel is a groove formed in the finial body.

4. A finial for a hinge in accordance with claim 1, wherein the compressible ring is made of a plastically deformable material.

5. A finial for a hinge in accordance with claim 1, wherein the compressible ring is made of an elastically deformable material.

6. The finial in accordance with claim 5, wherein the compressible ring is an o-ring.

7. The finial in accordance with claim 1, the hinge further comprising:
a first knuckle, having at least one hinge pin eyelet;
a second knuckle, having at least one hinge pin eyelet alignable with the at least one hinge pin eyelet of the doorframe knuckle; and
the hinge pin disposable in the eyelets of the first and second knuckles to align the eyelets; and
the first and second knuckles being pivotable about the hinge pin when disposed in the aligned eyelets.

8. A finial for use with a hinge that includes a plurality of knuckles and a hinge pin, the finial comprising:
a finial body, having an outside diameter substantially the same size as an outside diameter of the hinge pin;
a finial head, coupled to the finial body, abuttable against a shoulder of one of the knuckles to stop the finial as the finial body is disposed within the knuckle of the hinge;
a channel, formed circumferentially around the finial body;
a compressible insert, disposed circumferentially around the finial body and contained at least partially within the channel.

9. The finial as in claim 8, wherein the channel is a groove formed substantially about a circumference of the finial body.

10. A finial for a hinge in accordance with claim 8, wherein the compressible insert is made of an elastically deformable material.

11. The finial as in claim 10, wherein the compressible insert is an o-ring.

12. A hinge, comprising:
a first knuckle, having at least one hinge pin eyelet;
a second knuckle, having at least one hinge pin eyelet alignable with the at least one hinge pin eyelet of the doorframe knuckle;
a hinge pin, disposable in the eyelets of the first and second knuckles to align the eyelets, the first knuckle and second knuckle being pivotable about the hinge pin; and
a top and a bottom finial, disposable above and below the hinge pin in the aligned eyelets, each finial comprising:
a finial body, having an outside diameter substantially the same size as an outside diameter of the hinge pin;
a finial head, coupled to the finial body, abuttable against a shoulder of a knuckle to stop the finial as the finial body is disposed within an eyelet of the knuckle; and
a compressible ring, disposable circumferentially around the finial body.

13. A finial for a hinge in accordance with claim 12, further comprising a channel formed circumferentially around the finial body, configured to at least partially contain the compressible ring.

14. The finial as in claim 13, wherein the channel is a groove formed in the finial body.

15. A finial for a hinge in accordance with claim 12, wherein the compressible ring is made of a plastically deformable material.

16. A finial for a hinge in accordance with claim 12, wherein the compressible ring is made of an elastically deformable material.

17. The finial in accordance with claim 15, wherein the compressible ring is an elastomeric o-ring.

18. A method for securing a hinge pin in a hinge having a plurality of knuckles, comprising the steps of:
aligining eyelets of adjacent knuckle sections of the hinge with one another;
pressing an lower finial into a lower opening of the adjacent eyelets until a finial head of the lower finial stops movement of the lower finial and covers the eyelet, the lower finial including a compressible ring disposed about a finial body of the lower finial;
pressing a pin into an upper opening of the aligned eyelets toward the lower opening of the aligned eyelets until the lower finial stops movement of the pin; and
pressing an upper finial into the upper opening of the aligned eyelets until a finial head of the upper finial stops movement of the upper finial and covers the eyelet, the lower finial including a compressible ring disposed about a finial body of the lower finial.

19. A method for reducing movement of a finial within a hinge assembly, comprising the steps of:
obtaining a finial having a finial body, and a compressible ring disposed on the finial body; and
pressing the finial into an eyelet of a knuckle section of a hinge such that the compressible ring engages the eyelet and compresses about the finial body section to resist movement of the finial within the eyelet.

20. The method of claim 19, further comprising the step of:
placing the compressible ring at least partially within a circumferential groove formed in the finial body before pressing the finial into the eyelet.
